(19) United States
(12) Patent Application Publication
(10) Pub. No.: US 2021/0184338 A1
(43) Pub. Date: Jun. 17, 2021

(54) Method for Producing a Transmitting and/or Receiving Antenna on a Textile Carrier Material

(71) Applicant: Relytex GmbH & Co. KG, Landshut (DE)

(72) Inventors: Rolf Schumacher, Balingen (DE); Harald Katschke, Memmingerberg (DE); Robert Katschke, Bonbruck (DE)

(21) Appl. No.: 17/267,812

(22) PCT Filed: Aug. 20, 2018
(86) PCT No.: PCT/EP2018/072456

§ 371 Date: Feb. 11, 2021

(51) Int. Cl. H01Q 1/27; D04B 21/16; D04B 27/00; H01Q 1/22

(52) U.S. Cl. CPC H01Q 1/273; D04B 21/165; D10B 2401/16; H01Q 1/2208; D04B 27/00

(57) ABSTRACT

A method for producing at least one transmitting and/or receiving antenna (2) for transmitting and/or receiving electromagnetic waves. Electrically conductive threads are worked into a textile substrate material (1) as transmitting and/or receiving antennas (2) by means of a tricot machine or Raschel machine. The invention further relates to a corresponding transmitting and/or receiving antenna (2).

### CROSS REFERENCE TO RELATED APPLICATIONS

This application is the U.S. national stage of International Application No. PCT/EP2018/072456, filed on Aug. 20, 2018.

### BACKGROUND

The invention relates to a method for producing a transmitting and/or receiving antenna on a textile substrate material, as well as to a substrate material with a transmitting and/or receiving antenna.

Textiles are increasingly used for technical applications of all types. In particular, equipping textiles with transmitting and/or receiving antennas is known, wherein with such transmitting and/or receiving antennas, electromagnetic waves can be transmitted and/or received. In particular, such transmitting and/or receiving antennas can be designed as RFID antennas.

Generally, RFID chips are associated with such RFID antennas. By means of a read/write device, information can be read from the RFID chip, wherein for this purpose data saved in the RFID chip is transmitted to the read/write device by means of the RFID antenna. In particular, such RFID systems can serve to create identification systems, but also to create monitoring systems.

Depending on the transmission behavior and frequency range of the electromagnetic waves to be transmitted or received, the transmitting and/or receiving antennas must have certain geometric structures and certain lengths.

In order to produce such transmitting and/or receiving antennas, applying these by stitching electrically conductive threads onto an electrically insulating textile substrate material is known.

Although complex structures of transmitting and/or receiving antennas can be deliberately created on the substrate material by stitching, it is disadvantageous that the stitching process is very slow, which results in unacceptably long production times.

### SUMMARY

The invention relates to a method for producing at least one transmitting and/or receiving antenna (2) for transmitting and/or receiving electromagnetic waves. Electrically conductive threads are worked into a textile substrate material (1) as transmitting and/or receiving antennas (2) by means of a tricot machine or Raschel machine. The invention further relates to a corresponding transmitting and/or receiving antenna (2).

### DETAILED DESCRIPTION

The invention seeks to solve the problem of providing a method by means of which any given shape of transmitting and/or receiving antennas can be worked efficiently into a textile substrate material.

The features of the independent claims are intended to provide a solution to this problem. Advantageous embodiments and appropriate further developments of the invention are provided in the dependent claims.

The invention relates to a method for producing at least one transmitting and/or receiving antenna for transmitting and/or receiving electromagnetic waves. Electrically conductive threads are worked into a textile substrate material as transmitting and/or receiving antennas by means of a tricot machine or Raschel machine.

The invention further relates to a textile substrate material with a transmitting and/or receiving antenna. The transmitting and/or receiving antenna is formed by electrically conductive threads that are worked into the substrate material by means of a tricot machine or Raschel machine.

An essential advantage of the invention consists in that, with a tricot machine or Raschel machine, especially advantageously by means of a nonwoven Raschel machine, transmitting and/or receiving antennas can be worked into a textile substrate material. The transmitting and/or receiving antennas formed from electrically conductive threads can therefore be rapidly and efficiently worked into the substrate material, such that an economical process is ensured for the transmitting and/or receiving antennas.

Another advantage of the invention is that with the tricot machine or Raschel machine, transmitting and/or receiving antennas can be produced in virtually any shape and geometry, whereby especially the length of the transmitting and/or receiving antenna that encompasses the frequency range of electromagnetic waves to be transmitted or received can be flexibly prescribed.

It is especially advantageous for the tricot machine or Raschel machine to have a variable weft insertion by means of which the length of a transmitting and/or receiving antenna is prescribed.

Therefore, the length of the transmitting and/or receiving antennas can be prescribed especially simply, efficiently, and precisely.

According to an advantageous embodiment of the invention, the tricot machine or Raschel machine has electronic guide bars by means of which the position of a transmitting and/or receiving antenna can be freely prescribed on the textile substrate material.

In contrast to conventional guide bars, the electronic guide bars of the tricot machine or Raschel machine are not pattern-bound, such that these electronic guide bars can be used to freely prescribe the positions of the transmitting and/or receiving antennas on the substrate material without design restrictions.

In principle, a single guide bar of the tricot machine or Raschel machine can be used for producing a transmitting and/or receiving antenna. In this case, the electrically conductive thread(s) of the transmitting and/or receiving antenna form(s) an open structure, i.e., the electrically conductive threads run between an origin and end point along a freely selectable path.

According to an advantageous further development, the tricot machine or Raschel machine has at least two guide bars running in counter lapping operating mode, by means of which the transmitting and/or receiving antenna is created with closed structures of electrically conductive threads.

In general, both open and closed structures can be combined with one another in transmitting and/or receiving antennas.

Therefore, with the method according to the invention, the geometries of transmitting and/or receiving antennas to be produced can be varied across a wide range, such that a large number of different applications can be realized.

The electrically conductive threads used to produce the transmitting and/or receiving antennas consist, in full or in part, of an electrically conductive material.

In this regard, metallic and non-metallic materials can generally be used.

According to a specific embodiment, the electrically conductive threads have an electrically conductive core and an electrically insulating sheath.

The textile substrate material generally forms an electrically insulating structure upon which the transmitting and/or receiving antennas are applied, i.e., the textile substrate material consists entirely of electrically non-conductive materials.

In this regard, the textile substrate material can be a woven, knitted, nonwoven, non-crimp fabric or braided fabric.

It is expedient for the electrically conductive threads that form the transmitting and/or receiving antennas to be affixed to the textile substrate material by means of electrically insulating binding threads.

It is especially advantageous for the binding threads to be applied to the textile substrate material by means of at least one guide bar of the tricot machine or Raschel machine.

This means it is possible, using the same tricot machine or Raschel machine with which the electrically conductive threads to form the transmitting and/or receiving antenna are worked into the textile substrate material, to work in also the binding threads to affix the transmitting and/or receiving antenna, whereby the working-in of the electrically conductive threads into the substrate material and their affixing with the binding threads can take place within a single work process, which results in a high degree of efficiency.

It is advantageous in this regard for the density of binding threads to be varied depending upon the geometric structure of the transmitting and/or receiving antennas.

In this way, the transmitting and/or receiving antenna is affixed especially well to the substrate material, while simultaneously the amount of material used for binding threads is kept low.

In the regions with high curvature in the transmitting and/or receiving antennas, the density of binding threads is higher than in the regions with low curvature, since in the regions of the transmitting and/or receiving antennas with high curvature, more binding threads per unit of length are required in order to securely affix this highly curved structure.

The textile substrate materials according to the invention with the transmitting and/or receiving antennas applied thereupon can be used for a plurality of different applications, depending on the form of the transmitting and/or receiving antennas.

According to a first embodiment, the transmitting and/or receiving antenna is an RFID antenna.

In this case, an RFID chip is associated with the transmitting and/or receiving antenna. The RFID chip can be glued onto the substrate material and capacitively coupled to the RFID antenna.

This unit functions together with a read/write device such that data can be read from the RFID chip and can be transmitted to the read/write device by means of the RFID antenna.

For example, such a system can be designed as an identification system. In this case, identification data is stored in the RFID chip, by means of which an object tagged with the RFID chip can be identified.

Furthermore, such an RFID system can be a component of a monitoring system. For example, sensor signals from sensors installed for monitoring purposes can be stored on the RFID chip and read by the read/write device for the purpose of performing checks.

An example of such a monitoring system is a tarpaulin on which conductive sensor structures are worked in across the entire surface. In the event of manipulation, especially penetration of the conductive structures, the sensor structures generate sensor signals that can be transmitted to the read/write device by the RFID chip. Objects requiring protection can be securely packed with such tarpaulins.

According to a second embodiment, the transmitting and/or receiving antenna is designed for an NFC or radio transmission.

In this case, the transmitting and/or receiving antennas applied onto the substrate material are components of communication systems for contactless data transfer.

In NFC systems, data is transferred over relatively short distances.

In radio transmission systems, the data transfer can also occur over larger distances.

An example of this are transmitting and/or receiving antennas worked into the sails of sailing ships, by means of which antennas a radio transmission can occur over very large distances in the MHz range.

### BRIEF DESCRIPTION OF THE DRAWINGS

The invention is explained below based on the drawings. They show:

FIG. 1: A first exemplary embodiment of the substrate material according to the invention with a transmitting and/or receiving antenna applied onto it.

FIG. 1A: Enlarged detail depiction of the arrangement according to FIG. 1.

FIG. 2: A second exemplary embodiment of the substrate material according to the invention with a transmitting and/or receiving antenna applied onto it.

### DETAILED DESCRIPTION OF THE PREFERRED EMBODIMENTS

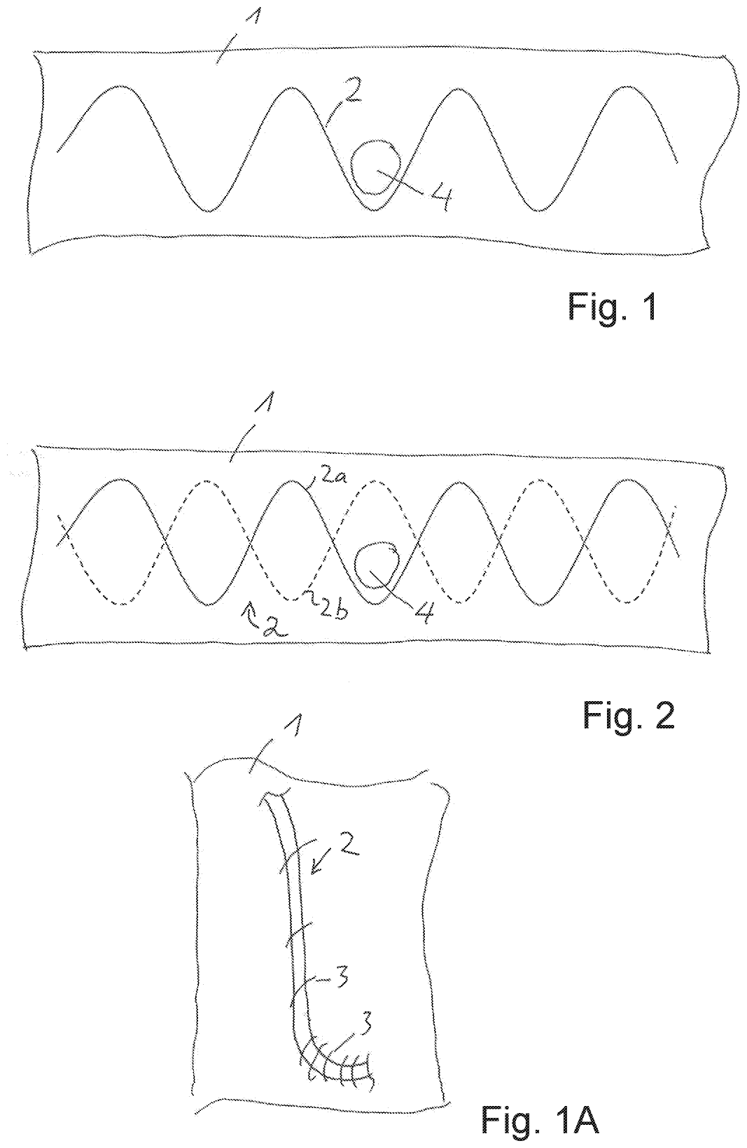

FIG. 1 shows a first exemplary embodiment of the textile substrate material 1 according to the invention, with a transmitting and/or receiving antenna 2 applied onto it.

The textile substrate material 1 consists of electrically non-conductive materials, i.e. of electrically insulating yarns or threads.

The textile substrate material 1 can be a woven, knitted, nonwoven, non-crimp fabric or braided fabric.

The transmitting and/or receiving antenna 2 applied to the textile substrate material 1 generally serves to send and/or receive electromagnetic waves. In the present case, the transmitting and/or receiving antenna 2 is designed as an RFID antenna and is a component of an RFID system.

The transmitting and/or receiving antenna 2 is composed of one or of multiple electrically conductive threads. The electrically conductive threads can be entirely composed of electrically conductive materials, which generally can be composed of metallic or non-metallic materials. In this regard, the phrase electrically conductive thread generally also comprises thin wires. Alternatively, the electrically conductive threads can also be only partly composed of electrically conductive materials.

The electrically conductive threads can have an electrically conductive core and an electrically insulating sheathing.

The insulating sheathing can consist of non-conductive threads that entwine the electrically conductive core. Alternatively, the electrically conductive core can also be sheathed with an electrically insulating coating.

According to the invention, the electrically conductive threads that form the transmitting and/or receiving antennas 2 are worked into the textile substrate material 1 with a tricot machine or Raschel machine. In the present case, a nonwoven Raschel machine is used to produce the transmitting and/or receiving antenna 2.

This nonwoven Raschel machine has a variable weft insertion with which the length of the transmitting and/or receiving antenna 2 can be selectively and precisely prescribed. With the length of the transmitting and/or receiving antenna 2, the frequency range within which the transmitting and/or receiving antenna 2 can send and/or receive electromagnetic waves is prescribed.

Furthermore, the nonwoven Raschel machine has electric guide bars that are not bound to pattern-repeat. Therefore, the position of the transmitting and/or receiving antenna 2 can be freely prescribed on the textile substrate material 1.

In the present case, the transmitting and/or receiving antenna 2 forms an open structure that runs from an origin point to an end point. The transmitting and/or receiving antenna 2 runs along a wave-shaped path.

The electrically conductive threads forming the transmitting and/or receiving antenna 2 are fastened within the textile substrate material 1 by means of binding threads 3 (FIG. 1A).

According to the invention, the binding threads 3, which are composed of electrically non-conductive materials, are worked in with at least one additional guide bar of the nonwoven Raschel machine, such that the application of the electrically conductive threads forming the transmitting and/or receiving antenna 2 and their affixing using the binding threads 3 can be accomplished with the nonwoven Raschel machine in a single work process.

As can be seen in FIG. 1A, the density of the binding threads 3 varies depending on the geometrical structure of the transmitting and/or receiving antenna 2.

In the regions of the transmitting and/or receiving antenna 2 with high curvature, a large number of binding threads 3 per unit of length is provided in order to securely affix onto the substrate material 1 their highly curved sections of the transmitting and/or receiving antenna 2 while preserving the shape of said sections. Conversely, in the regions of the transmitting and/or receiving antenna 2 with low curvature, a lower number of binding threads 3 is provided per unit of length.

As an additional component of the RFID system, an RFID chip 4 is provided, which is glued onto the textile substrate material 1. The RFID chip 4 is capacitively coupled to the RFID antenna, i.e., there is no direct conductive connection between the RFID chip 4 and the RFID antenna.

The RFID system further comprises a read/write device (not shown). Data stored in the RFID chip 4 can be transmitted to the read/write device by means of the RFID antenna. This transmission typically occurs in response to a request from the read/write device that is received using the RFID antenna.

FIG. 2 shows another exemplary embodiment of the substrate material 1 according to the invention, with a transmitting and/or receiving antenna 2 applied onto it.

The exemplary embodiment in FIG. 2 differs from the example in FIG. 1 only insofar as now the transmitting and/or receiving antenna 2 forms a closed structure.

The closed structure of the transmitting and/or receiving antenna 2 is formed by two antenna structures 2a, 2b running out of phase, which are respectively formed by electrically conductive threads.

The two antenna structures 2a, 2b are created using two guide bars of the nonwoven Raschel machine running in counter lapping mode.

### LIST OF REFERENCE NUMERALS

(1) substrate material

(2) transmitting and/or receiving antenna

(2a) antenna structure

(2b) antenna structure

(3) binding thread

(4) RFID chip

1. A method for producing at least one transmitting and/or receiving antenna (2) for transmitting and/or receiving electromagnetic waves, characterized in that electrically conductive threads can be worked into a textile substrate material (1) as a transmitting and/or receiving antenna (2) by a tricot machine or Raschel machine.

2. The method according to claim 1, characterized in that the electrically conductive threads are worked into the textile substrate material (1) by means of a nonwoven Raschel machine.

3. The method according to claim 1, characterized in that the tricot machine or Raschel machine has a variable weft insertion by means of which the length of a transmitting and/or receiving antenna (2) can be prescribed.

4. The method according to claim 1, characterized in that the tricot machine or Raschel machine has electronic guide bars by means of which the position of a transmitting and/or receiving antenna (2) on the textile substrate material (1) can be freely prescribed.

5. The method according to claim 1, characterized in that the tricot machine or Raschel machine has at least two guide bars running in counter lapping mode, by means of which transmitting and/or receiving antennas (2) with closed structures are created from electrically conductive threads.

6. The method according to claim 1, characterized in that the electrically conductive threads forming the transmitting and/or receiving antenna (2) are affixed to the textile substrate material (1) by means of electrically insulating binding threads (3).

7. The method according to claim 6, characterized in that the binding threads (3) are applied onto the textile substrate material (1) by means of at least one guide bar of the tricot machine or Raschel machine.

8. The method according to claim 7, characterized in that the density of the binding threads (3) is being varied depending on the geometric structure of the transmitting and/or receiving antenna (2).

9. The method according to claim 1, characterized in that the electrically conductive threads are composed, completely or in part, of an electrically conductive material.

10. The method according to claim 9, characterized in that the electrically conductive threads have an electrically conductive core and an electrically insulating sheathing.

11. The method according to claim 1, characterized in that the textile substrate material (1) is completely composed of electrically non-conductive materials.

12. The method according to claim 1, characterized in that the textile substrate material (1) is a woven, knitted, nonwoven, non-crimp fabric or braided fabric.

13. A textile substrate material (1) with a transmitting and/or receiving antenna (2), characterized in that the transmitting and/or receiving antenna (2) is made of electrically conductive threads which are worked into the substrate material (1) by means of a tricot machine or Raschel machine.

14. The substrate material (1) according to claim 13, characterized in that the transmitting and/or receiving antenna (2) is an RFID antenna.

15. The substrate material (1) according to claim 13, characterized in that the transmitting and/or receiving antenna (2) is designed for an NFC or radio transmission.
